(19) United States
(12) Patent Application Publication
(10) Pub. No.: US 2004/0263666 A1
(43) Pub. Date: Dec. 30, 2004

(54) Lens barrier mechanism and image pickup apparatus

(76) Inventors: Kiyoaki Tsuji, Kanagawa (JP); Masaaki Kamoda, Saitama (JP)

Correspondence Address: JAY H. MAIOLI, Cooper & Dunham LLP, 1185 Avenue of the Americas, New York, NY, 10036, US

(21) Appl. No.: 10/825,340

(22) Filed: Apr. 15, 2004

(30) Foreign Application Priority Data
Apr. 21, 2003 (JP) P2003-116206
Apr. 21, 2003 (JP) P2003-116207

(51) Int. Cl. H04N 5/225

(52) U.S. Cl. 348/335

(57) ABSTRACT

A lens barrier mechanism includes: a lens tube; a lens barrier rotated in a direction orthogonal to an optical axis of an image pickup lens exposed outward from a front part of the lens tube for opening/closing the front part of the lens tube; a first energizing member for rotationally energizing the lens barrier; a slider engaged with the lens barrier and sliding in the direction of the optical axis of the image pickup lens, thus regulating rotation of the lens barrier; a second energizing member for energizing the slider so as to rotate the lens barrier in a direction opposite to the energizing direction of the first energizing member; and a sliding mechanism for moving the slider.

### BACKGROUND OF THE INVENTION

1. Field of the Invention

This invention relates to an image pickup apparatus and particularly to a lens barrier for protecting a lens of an image pickup apparatus.

This application claims priority of Japanese Patent Applications No.2003-116206 and No.2003-116207, filed on Apr. 21, 2003, the entireties of which are incorporated by reference herein.

2. Description of the Related Art

An image pickup apparatus having a lens barrier for preventing taint and damage to a lens surface when the apparatus is not used has been conventionally used. An image pickup apparatus 100 of this type has an apparatus body 101 made of a substantially rectangular casing, and a substantially cylindrical lens tube 102 having an image pickup lens incorporated therein and a lens barrier 130 for protecting the image pickup lens and preventing taint and damage to the image pickup lens are provided in the apparatus body 101, as shown in FIG. 1.

One or plural image pickup lenses 105 are attached to a front side 102a of the lens tube 102, and an image pickup device 106 such as CCD for receiving incident light transmitted through the image pickup lens 105 is arranged on a rear side 102b. The image pickup lens 105 is formed on the front side 102a of the lens tube 102 and is exposed outward from an aperture, not shown, formed in a front part 101a of the apparatus body 101.

The lens barrier 103 for protecting the image pickup lens 105 is made of a plate-like member having a slightly larger area than the image pickup lens 105. The lens barrier 103 is supported within the apparatus body 101 in such a manner that the lens barrier 103 can slide in the longitudinal direction on the front part 101a of the apparatus body 101. A protrusion for opening/closing operation is formed on the lens barrier 103 and this protrusion is protruding outside of the apparatus body 101. Therefore, as a user operates the protrusion, the lens barrier 103 slides in the longitudinal direction on the front part 101a of the apparatus body 101 and moves between a closing position where the lens barrier 103 covers the image pickup lens 105 entirely and an opening position where the lens barrier 103 opens the image pickup lens 105 entirely.

In the image pickup apparatus 100, when picking up an image, the protrusion of the lens barrier 103 is operated to slide the lens barrier 103 to the opening position where the lens barrier 103 opens the image pickup lens 105 entirely, and then an image is picked up. After an image is picked up, the lens barrier 103 is slid to the closing position where the lens barrier 103 covers the image pickup lens 105 entirely so as to prevent taint and damage to the image pickup lens 105 due to dust and particles.

To avoid increase in the size of the apparatus body that uses the flat plate-like lens barrier, a lens barrier mechanism 120 is used in which a lens barrier 110 is bisected into semicircular upper and lower barrier parts 110a, 110b that are supported to be vertically rotatable by axis supporting parts 111a, 111b, respectively, as shown in FIG. 2. In this lens barrier mechanism 120, as rotation rings, not shown, abutted against the axis supporting parts 111a, 111b are rotated, the axis supporting parts 111a, 111b are rotated vertically and the upper and lower barrier parts 110a, 110b are slid in the directions of arrows r and r′ in FIG. 2 to open or close the lens tube.

Patent Reference 1: JP-A-10-148871

Patent Reference 2: JP-A-2002-258133

In the above-described image pickup apparatus 100, the lens barrier 103 is arranged on the front part 101a of the apparatus body 101 and is made slidable in the longitudinal direction. Therefore, the space for movement of the lens barrier 103 must be provided in the longitudinal direction of the front part 101a of the apparatus body 101 and it is difficult to miniaturize the apparatus body 101.

In the lens barrier mechanism 120, the operation of the lens barrier 103 lacks stability and reliability because of the complicated mechanism. Moreover, if disturbance such as vibration occurs at the time of opening or closing the lens barrier, the complicated mechanism may lead to damage to the members constituting the lens barrier mechanism 120. Furthermore, if a user's finger or other foreign matter is caught between the upper and lower barrier parts 110a, 110b at the time of opening or closing, an excessive load is put on the driving unit, making the mechanism less durable.

Thus, it is an object of this invention to provide a lens barrier that enables saving of the space on the front part of the lens tube and can open/close stably, and an image pickup apparatus using this lens barrier.

In the image pickup apparatus 100, when picking up an image, a power switch provided on the apparatus body 101 must be operated to turn on the main power and the lens barrier 103 must be slid to open the image pickup lens 105. After the pickup of an image is completed, the lens barrier 103 must be slid to cover the image pickup lens 105 and the power switch of the apparatus body 101 must be operated to turn off the main power. If these operations can be interlocked with the opening/closing operation of the lens barrier 103, the operations can be simplified and the number of components can be reduced conveniently.

Thus, it is an object of this invention to provide a camera lens barrier that enables saving of the space on the front part of the lens tube and execution of an on/off operation of the main power of the apparatus body interlocked with the operation of the lens barrier, and an image pickup apparatus using this camera lens barrier.

### SUMMARY OF THE INVENTION

To solve the above-described problems, a lens barrier mechanism according to this invention has: a lens tube; a lens barrier rotated in a direction orthogonal to an optical axis of an image pickup lens exposed outward from a front part of the lens tube for opening/closing the front part of the lens tube to protect the image pickup lens; a first energizing member for rotationally energizing the lens barrier; a slider engaged with the lens barrier and sliding in the direction of the optical axis of the image pickup lens, thus regulating rotation of the lens barrier; a second energizing member for energizing the slider with an energizing force that is larger than the energizing force of the first energizing member into a direction of rotating the lens barrier in a direction opposite to the energizing direction of the first energizing member; and a movement mechanism abutted against one end side in the sliding direction of the slider for moving the slider. The lens barrier mechanism has an opening/closing mechanism for rotationally operating the lens barrier. The movement mechanism moves the slider into a direction opposite to the energizing direction of the second energizing member and rotates the lens barrier in the energizing direction of the first energizing member, thus opening or closing the front part of the lens tube. The movement mechanism moves the slider into the energizing direction of the second energizing member and rotates the lens barrier into the direction opposite to the energizing direction of the first energizing member by the energizing force of the second energizing member, thus closing or opening the front part of the lens tube.

To solve the above-described problems, a camera lens barrier according to this invention has: a lens tube; a lens barrier rotated in a direction orthogonal to an optical axis of an image pickup lens exposed outward from a front part of the lens tube for opening/closing the front part of the lens tube to protect the image pickup lens; and an opening/closing mechanism for opening/closing the lens barrier. The opening/closing mechanism turns on or off a main power of an image pickup apparatus body, interlocked with the opening/closing of the lens barrier.

An image pickup apparatus according to this invention has: a lens tube; a lens barrier rotated in a direction orthogonal to an optical axis of an image pickup lens exposed outward from a front part of the lens tube for opening/closing the front part of the lens tube to protect the lens; and an opening/closing mechanism for opening/closing the lens barrier. The opening/closing mechanism turns on or off a main power of an image pickup apparatus body, interlocked with the opening/closing of the lens barrier

Moreover, an image pickup apparatus according to this invention has: a lens tube; a lens barrier rotated in a direction orthogonal to an optical axis of an image pickup lens exposed outward from a front part of the lens tube for opening/closing the front part of the lens tube to protect the image pickup lens; a first energizing member for rotationally energizing the lens barrier; a slider engaged with the lens barrier and sliding in the direction of the optical axis of the image pickup lens, thus regulating rotation of the lens barrier; a second energizing member for energizing the slider with an energizing force that is larger than the energizing force of the first energizing member into a direction of rotating the lens barrier in a direction opposite to the energizing direction of the first energizing member; and a movement mechanism abutted against one end side in the sliding direction of the slider for moving the slider. The image pickup apparatus has an opening/closing mechanism for rotationally operating the lens barrier. The movement mechanism moves the slider into a direction opposite to the energizing direction of the second energizing member and rotates the lens barrier in the energizing direction of the first energizing member, thus opening or closing the front part of the lens tube. The movement mechanism moves the slider into the energizing direction of the second energizing member and rotates the lens barrier into a direction opposite to the energizing direction of the first energizing member by the energizing force of the second energizing member, thus closing or opening the front part of the lens tube.

In the lens barrier and the image pickup apparatus according to this invention, as a slide cam is slid, the lens barrier for preventing taint and damage to the image pickup lens is rotated in the direction substantially orthogonal to the optical axis of the image pickup lens and thus opens/closes a lens unit that exposes the image pickup lens outward. Therefore, in this image pickup apparatus, a large rotation space for the lens barrier need not be provided on the front part of the lens tube and the apparatus can be miniaturized.

Moreover, in the lens barrier and the image pickup apparatus according to this invention, the opening/closing operation is carried out by using the two energizing members having different energizing forces for rotating the lens barrier. Therefore, even if a user's finger or other foreign matter is caught in the lens barrier at the time of closing the lens barrier, an excessive load is not put on the movement mechanism or the like and the opening/closing mechanism will not lose its durability.

Furthermore, the camera lens barrier and the image pickup apparatus according to this invention, as the slide cam is slid, the lens barrier for preventing taint and damage to the image pickup lens is rotated in the direction substantially orthogonal to the optical axis and thus opens/closes the image pickup lens. At the same time, the main power of the lens unit can be turned on or off, interlocked with the rotation of the lens barrier. Therefore, in this image pickup apparatus, a large rotation space for the lens barrier need not be provided on the front part of the lens tube and the apparatus can be miniaturized. In this image pickup apparatus, since the main power can be turned on or off, interlocked with the rotation of the lens barrier, the operations at the time of starting image pickup and after the completion of image pickup can be simplified and the number components can be reduced.

### BRIEF DESCRIPTION OF THE DRAWINGS

FIG. 1 is a perspective view showing a conventional lens barrier.

FIG. 2 is a perspective view showing another conventional lens barrier.

FIG. 3 is a perspective view showing an image pickup apparatus to which this invention is applied.

FIG. 4 is a perspective view showing the image pickup apparatus from which a lens unit is separated.

FIGS. 5A and 5B are side and bottom views showing a lens tube in which an image pickup lens is opened by a lens barrier.

FIGS. 6A and 6B are side and bottom views showing the lens tube in which the image pickup lens is covered by the lens barrier.

FIG. 7 is a perspective view showing the lens tube in which the image pickup lens is opened by the lens barrier.

FIG. 8 is a perspective view showing the lens tube in which the image pickup lens is covered by the lens barrier.

FIG. 9 is an exploded perspective view showing the lens tube and a movement mechanism.

FIG. 10 is a side view showing the lens tube in which the image pickup lens is opened by the lens barrier.

FIG. 11 is a side view showing the lens tube in which the image pickup lens is covered by the lens barrier.

FIG. 12 is a side view showing a lens tube having a lens barrier including upper and lower barrier parts.

FIG. 13 is a side view showing the lens tube having the lens barrier including the upper and lower barrier parts.

FIG. 14 is a side view showing a lens unit in which a lens barrier can be manually opened/closed.

FIG. 15 is a side view showing the lens unit in which the lens barrier can be manually opened/closed.

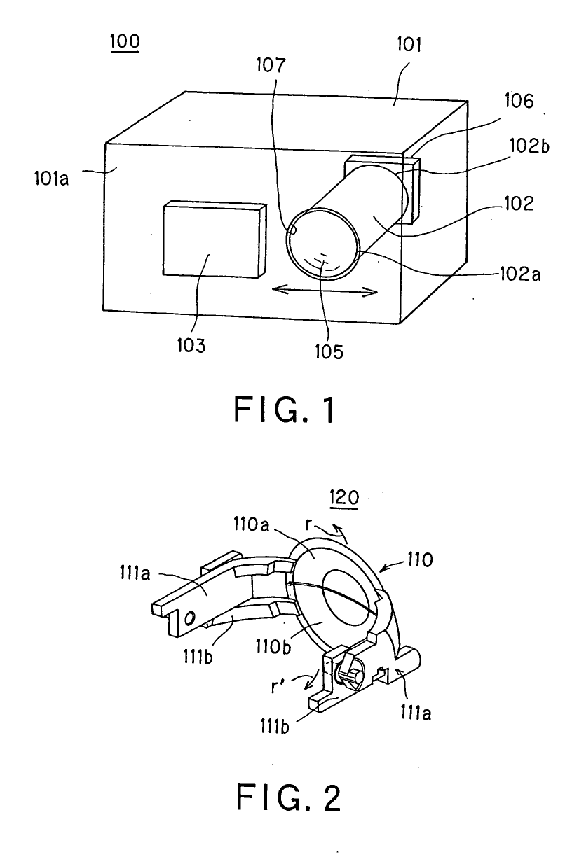

### DESCRIPTION OF THE PREFERRED EMBODIMENTS

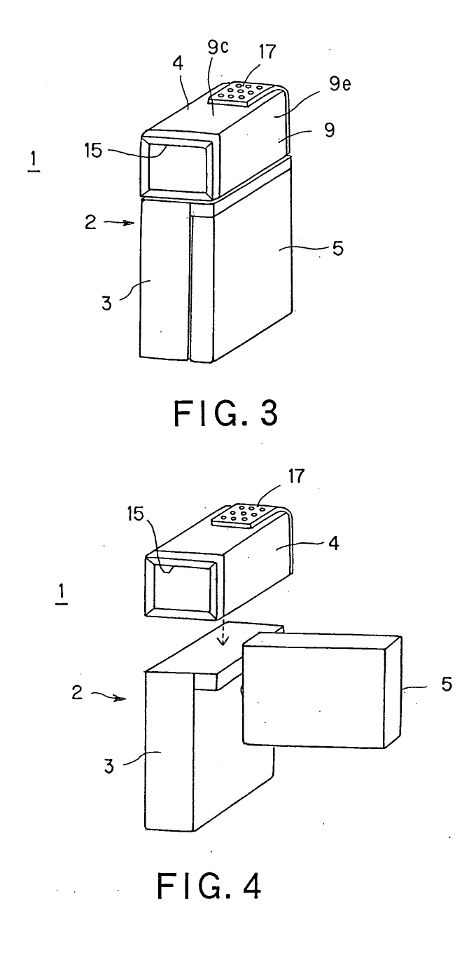

A lens barrier mechanism to which this invention is applied and an image pickup apparatus using this lens barrier mechanism will now be described in detail with reference to the drawings. An image pickup apparatus 1 using a lens barrier mechanism to which this invention is applied has an apparatus body 2 formed by a substantially rectangular casing, as shown in FIG. 3. The apparatus body 2 includes a body part 3 including a driving circuit or the like and having an operating part formed thereon, a lens unit 4 in which an image pickup lens is arranged, and a liquid crystal display part 5 for displaying an image formed by the lens unit 4.

In the image pickup apparatus 1, the lens unit 4 is attachable to and removable from the body part 3, as shown in FIG. 4. The lens unit 4 can be replaced with another lens system having different magnification and focal length so that the apparatus can be modified by the replacement of the lens unit. In the image pickup apparatus 1, the liquid crystal display part 5 can be rotated from the body part 3 so that its liquid crystal screen faces the operator. Therefore, the operator holding the body part 3 can pick up an image or reproducing the picked-up image while easily confirming the image projected on the lens unit 4.

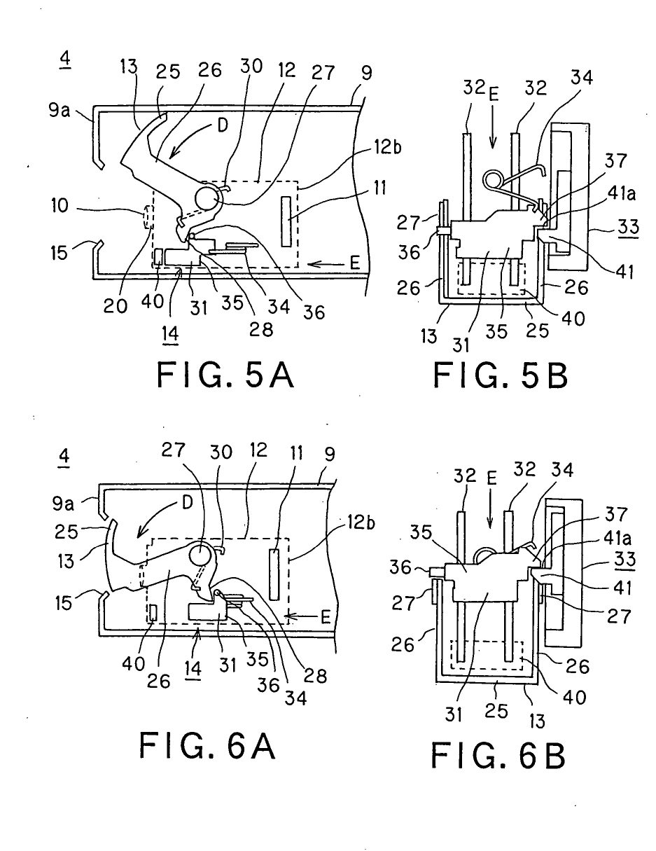

The lens unit 4 of the image pickup apparatus 1 has a casing 9 formed by a substantially rectangular solid, and in the casing 9, a lens tube 12 in which an image pickup lens 10 and an image pickup device 11 such as CCD are provided, a lens barrier 13 rotated between the top side of the image pickup lens 10 shown in FIGS. 5A and 5B and the front side of the image pickup lens 10 shown in FIGS. 6A and 6B so as to protect the image pickup lens 10, and an opening/closing mechanism 14 for opening/closing the lens barrier 13 are provided, as shown in FIGS. 5A and 5B and FIGS. 6A and 6B.

FIGS. 5A and 6A show the inside of the lens unit 4 from its lateral side. FIGS. 5B and 6B show the inside of the lens tube 12 from its bottom side.

On a front part 9a of the casing 9, an aperture 15 for exposing the image pickup lens 10 outward is formed, as shown in FIGS. 5A and 5B and FIGS. 6A and 6B. On a top part 9c of the casing 9, an audio microphone 17 is provided, as shown in FIGS. 3 and 4.

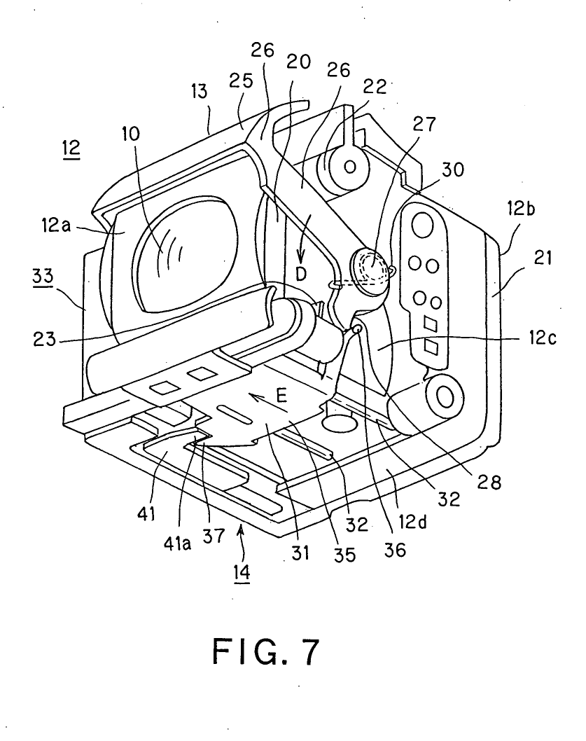

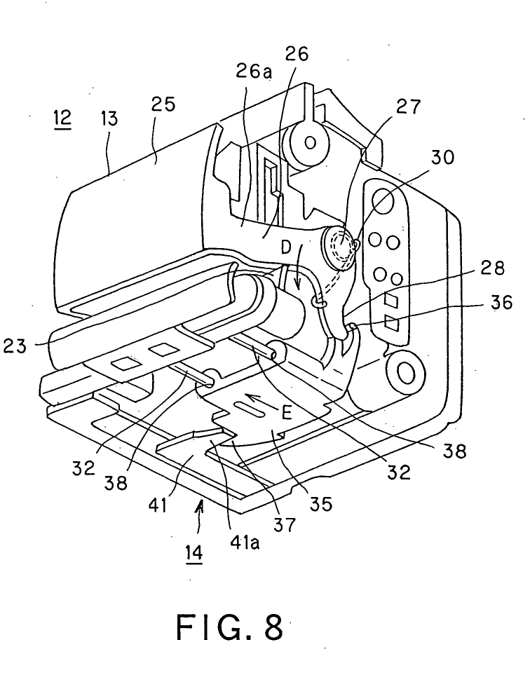

On a front part 12a of the lens tube 12 holding the image pickup lens 10 and the image pickup device 11, a lens holder 20 for holding the image pickup lens 10 is provided, and an image pickup device housing part 21 housing the image pickup device 11 such as CCD is formed on a rear part 12b, as shown in FIGS. 7 and 8. On a lateral part 12c of the lens tube 12, the lens barrier 13 rotated vertically on the front side of the image pickup lens 10 so as to protect the image pickup lens 10 is attached, and the opening/closing mechanism 14 for regulating the rotation of the lens barrier 13 to open/close the lens barrier 13 is formed on a bottom part 12d.

One or plural image pickup lenses 10 are held by the lens holder 20. The image pickup lens 10 is held to be movable in the direction of the optical axis by a focusing mechanism, not described in detail. The image pickup lens 10 is focus-controlled by the focusing mechanism that has received a control signal from a control unit provided in the body part 3.

The image pickup device 11 such as CCD housed in the image pickup device housing part 21 photoelectrically converts an image entered to the image pickup lens 10, thus generates an image signal and outputs this image signal to a signal processing circuit formed in the body part 3.

The lens barrier 13 rotatably attached on the lateral part 12c of the lens tube 12 has a substantially rectangular barrier part 25 for protecting the image pickup lens 10, a pair of rotation arms 26, 26 extended from both lateral parts of the barrier part 25, and rotation supporting parts 27, 27 for supporting the rotation arms 26, 26 in a rotatable manner.

The barrier part 25 is formed in a substantially rectangular plate-like shape and is slightly curved in an arcuate shape along the rotating direction. The barrier part 25 is large enough to cover the entire surface of the image pickup lens 10. As the barrier part 25 is connected with the rotation arms 26, 26, the barrier part 25 is rotated arcuately between the front part and the top part of the image pickup lens 10 by the rotation of the rotation arms 26, 26.

The distal ends 26a of the pair of rotation arms 26, 26 are continued to the barrier part 25 and their proximal ends 26b are attached to the lateral parts of the lens tube 12 in a rotatable manner by the rotation supporting parts 27, 27. As the rotation arms 26, 26 are supported by the rotation supporting parts 27, 27, the rotation arms 26, 26 can rotate in the direction of an arrow D in FIGS. 7 and 8 for closing the aperture 15 of the lens unit 4 and the direction opposite to the arrow D in FIGS. 7 and 8 for opening the aperture 15 and exposing the image pickup lens 10 outward, both direction being substantially orthogonal to the direction of the optical axis of the image pickup lens 10.

A torsion coil spring 30 is wound on one of the rotation supporting parts 27 for supporting the rotation arms 26. As this torsion coil spring 30 has its one end retained by the rotation arm 26 and has its other end retained by the lens tube 12, it constantly energizes the rotation arms 26, 26 in the direction of the arrow D in FIGS. 7 and 8 for the barrier part 25 to cover the image pickup lens 10. On the proximal end 26b of the rotation arms 26, 26, an abutment part 28 abutted against a slide cam of the opening/closing mechanism 14, which will be described later, is formed. As the abutment part 28 is pressed by the slide cam, the rotation arms 26, 26 rotate in the direction opposite to the arrow D in FIGS. 7 and 8.

Upper and lower stopper walls 22, 23 for regulating the rotation range of the rotation arms 26, 26 are formed on the lateral part 12c of the lens tube 12. The rotation arms 26, 26 rotate between these upper and lower stopper walls 22, 23.

As the lens barrier 13 is rotatably supported by the rotation supporting parts 27 provided on both lateral parts of the lens tube 12 and having a rotational axis orthogonal to the direction of the optical axis of the image pickup lens 10, the lens barrier 13 is rotatable in the direction of the arrow D and the direction opposite to the arrow D in FIGS. 7 and 8, which are substantially orthogonal to the optical axis of the image pickup lens 10. The lens barrier 13 is situated on the front part of the image pickup lens 10 by the torsion coil spring 30 for constantly energizing the lens barrier 13 in the direction of the arrow D in FIGS. 6A and 7 for closing the image pickup lens 10, and thus prevents taint and damage to the image pickup lens 10. At the time of image pickup, the rotation arms 26, 26 are pressed by the slide cam of the opening/closing mechanism 14, which will be described later, against the energizing force of the torsion coil spring 30 and thus rotate in the direction opposite to the arrow D in FIGS. 7 and 8. The barrier part 25 rotates from the front part to the top part of the image pickup lens 10 to open the image pickup lens 10.

The opening/closing mechanism 14, which opens/closes the lens barrier 13 by regulating the rotation of the rotation arms 26, 26, is formed on the bottom part 12d of the lens tube 12. The opening/closing mechanism 14 has a slide cam 31 for pressing the rotation arms 26, 26, a pair of guide shafts 32, 32 arranged parallel to the optical axis of the image pickup lens 10 and adapted for guiding the movement of the slide cam 31, a movement mechanism 33 for moving the slide cam 31 between one end side and the other end side of the guide shafts 32, 32, and an energizing member such as a torsion coil spring 34 for energizing the slide cam 31.

The slide cam 31 has a substantially rectangular plate-like cam body 35, a pressing part 36 continued to the cam body 35 and adapted for pressing the above-described abutment part 28 of the rotation arms 26, and an engagement part 37 continued to the cam body 35 and adapted for being engaged with the movement mechanism 33, which will be described later, as shown in FIGS. 7 and 8. From the front side to the rear side of the cam body 35, a pair of insertion holes 38, 38 are provided in which the pair of guide shafts 32, 32 are inserted. The cam body 35 is guided by the guide shafts 32, 32 arranged parallel to the optical axis of the image pickup lens 10 and is thus made movable in the direction of an arrow E and the direction opposite to the arrow E in FIGS. 7 and 8, which are parallel to the optical axis of the image pickup lens 10.

The pressing part 36 for pressing the abutment part 28 of the rotation arms 26 is extended from one lateral part of the cam body 35. The pressing part 36 is abutted against the abutment part 28 of the rotation arms 26, 26 from the rear part 12b and presses the abutment part 28 of the rotation arms 26, 26 in the direction of the arrow E in FIGS. 7 and 8 in accordance with the movement of the cam body 35.

On the other lateral part opposite to the lateral part where the pressing part 36 of the cam body 35 is formed, the engagement part 37 to be engaged with the movement mechanism 33 is formed. An engagement protrusion 41a of an engagement piece 41 of the movement mechanism 33 is abutted against the engagement part 37 from the front part 12a of the lens tube 12. As the engagement piece 41 is moved in the direction opposite to the arrow E in FIG. 6B, the engagement part 37 of the slide cam 31 is pressed by the engagement protrusion 41a and the slide cam 31 is moved toward the rear part 12b of the lens tube 12.

The torsion coil spring 34 is retained by the cam body 35. As the torsion coil spring 34 is wound on the bottom part 12d of the lens tube 12 and has its other end retained by the lens tube 12, it energizes the cam body 35 in the direction of the arrow E in FIG. 5B and moves the cam body 35 toward the front part 12a of the lens tube 12. Since the engagement piece 41 of the movement mechanism 33 is abutted against the engagement part 37 from he front part 12a, the movement of the cam body 35 toward the front part 12a is regulated by the engagement piece 41. The cam body 35 is moved in the direction of the arrow E and the direction opposite to the arrow E in FIG. 5B in accordance with the movement of the engagement piece 41. Specifically, when the engagement piece 41 is moved toward the rear part 12b, the engagement part 37 is pressed and the cam body 35 moves toward the rear part 12b. When the engagement piece 41 is moved toward the front part 12a, the cam body 35 is energized by the torsion coil spring 34 and moves toward the front part 12a.

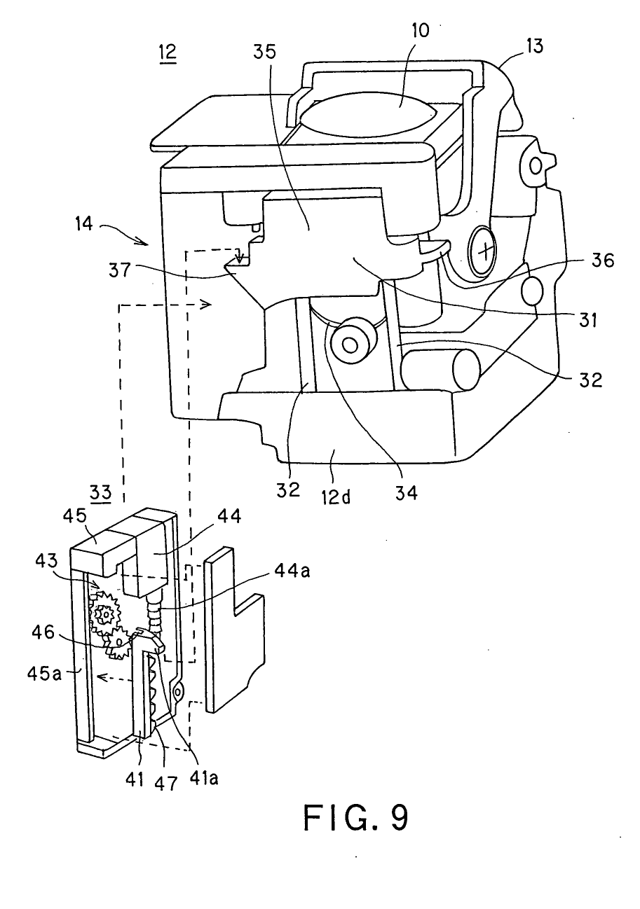

The movement mechanism 33, which moves the slide cam 31 by moving the engagement piece 41, has the engagement piece 41 engaged with the slide cam 31 and moving the slide cam 31 from the front part 12a to the rear part 12b of the lens tube 12, a gear part 43 for moving the engagement part 41, a driving motor 44 for driving the gear part 43, and a housing 45 supporting the engagement piece 41 in a such a manner that the engagement piece 41 can slide, as shown in FIG. 9.

The engagement piece 41 is formed in a substantially hook-like shape and has the engagement protrusion 41a to be abutted against the engagement part 37 of the slide cam 31. Also a slide groove 46 is formed in the longitudinal direction of the engagement piece 41. As the engagement piece 41 has the slide groove 46 engaged with a slide wall 45a of the housing 45 and is supported in this manner, the engagement piece 41 slides on the slide wall 45a. In this case, the engagement protrusion 41a of the engagement piece 41 protrudes from the housing 45 and is retained by the engagement part 37 of the slide cam 31, as shown in FIGS. 5B and 6B. Also a rack part 47 having teeth to be meshed with the gear part 43 is formed on a lateral part of the engagement piece 41.

The gear part 43, which meshes with the rack part 47 to linearly move the engagement piece 41, includes plural gear trains. The gear part 43 is engaged with a rotation groove of a rotation shaft 44a protruding from the driving motor 44 and converts the rotational movement of the driving motor 44 to the linear movement of the engagement piece 41 while decelerating the output of the rotational movement of the driving motor 44.

A DC motor is used as the driving motor 44. As the rotation shaft 44a is rotationally driven, the driving motor 44 moves the engagement piece 41 via the gear part 43 meshed with the rotation shaft 44a. In this manner, in the image pickup apparatus 1, since the slide cam 31 is slid without using a plunger or the like, the structure of the movement mechanism 33 can be simplified and miniaturized. In the image pickup apparatus 1, the engagement piece 41 may also be moved using a plunger.

In the movement mechanism 33, the housing 45 in which the engagement piece 41, the gear part 43 and the driving motor 44 are arranged is attached on the one lateral part 12c of the lens tube 12. In this case, the engagement protrusion 41a of the engagement piece 41, which is protruding from the housing 45, is engaged with the engagement part 37 of the slide cam 31 from the front part 12a of the lens tube 12.

In the opening/closing mechanism 14 as described above, when a lens opening/closing button of an operating part formed on the body part 3 or the lens unit 4 of the image pickup apparatus 1 is operated, the driving motor 44 of the movement mechanism 33 is driven and the engagement piece 41 is moved between the front part 12a and the rear part 12b of the lens tube 12 along the slide wall 45a of the housing 45 via the gear part 43.

When the engagement piece 41 is moved from the rear part 12b toward the front part 12a, the slide cam 31, in which the engagement protrusion 41a of the engagement piece 41 is abutted from the front part 12a is abutted against the engagement part 37, is moved in the direction of the arrow E in FIG. 5B toward the front part 12a of the lens tube 12 by the energizing force of the torsion coil spring 34 in accordance with the quantity of movement of the engagement piece 41.

When the engagement piece 41 is moved from the front part 12a toward the rear part 12b, the engagement part 37 of the slide cam 31 is pressed in the direction opposite to the arrow E in FIG. 6B by the engagement protrusion 41a of the engagement piece 41. Therefore, the slide cam 31 is moved in the direction opposite to the arrow E in FIG. 6B against the energizing force of the torsion coil spring 34 in accordance with the quantity of movement of the engagement piece 41.

When the slide cam 31 is moved toward the front part 12a or toward the rear part 12b, a reflection photo-interrupter on a sensor board provided on the bottom part 12d of the lens tube 12 detects the presence/absence o light reflected from the slide cam 31. The position of the cam body 35 is thus detected and the driving of the driving motor 44 is stopped.

On the front part 12a of the lens tube 12, a power switch 40 for an image pickup unit including the lens unit 4 is provided facing the cam body 35 of the slide cam 31. As the power switch 40 is abutted against the cam body 35 of the slide cam 31 slid toward the front part 12a of the lens tube 12, the power of the image pickup unit is turned on. As the slide cam 31 is slid toward the rear part 12b of the lens tube 12 and the power switch 40 is separated away from the cam body 35, the main power of the image pickup unit is turned off.

In the image pickup apparatus 1 having the above-described structure, before it is used, the engagement piece 41 is moved toward the rear part 12b of the lens tube 12 by the movement mechanism 33, and the slide cam 31 is held on the side of the rear part 12b of the lens tube 12, as shown in FIGS. 6A, 6B and 8. Therefore, the rotation arms 26, 26 are rotated in the direction of the arrow D by the energizing force of the torsion coil spring 30, and the lens barrier 13 covers the aperture of the lens unit 4, thus protecting the image pickup lens 10.

At the time of image pickup, as the operator operates the lens opening/closing button of the operating unit formed on the body part 3 or the like, the driving motor 44 of the movement mechanism 33 is driven and the engagement piece 41 is moved along the slide wall 45a of the housing 45 via the gear part 43 in the direction of the arrow E in FIGS. 5B and 7, that is, from the rear part 12b toward the front part 12a of the lens tube 12.

As the engagement piece 41 is moved in the direction of the arrow E, the slide cam 31 having the engagement part 37 engaged with the engagement protrusion 41a of the engagement piece 41 is slid in the direction of the arrow E in FIGS. 5B and 7 by the energizing force of the torsion coil spring 34.

The abutment part 28 of the lens barrier 13 is thus pressed into the direction of the arrow E in FIGS. 5B and 7 by the pressing part 36 of the cam body 35, and the rotation arms 26, 26 rotate in the direction opposite to the arrow D in FIG. 7 against the energizing force of the torsion coil spring 30. As the rotation arms 26, 26 rotate in the direction opposite to the arrow D, the barrier part 25 of the lens barrier 13 is rotated upward to open the image pickup lens 10, thus enabling image pickup.

The energizing force of the torsion coil spring 34 that energizes the slide cam 31 in the direction of the arrow E in FIG. 5B is larger than the energizing force of the torsion coil spring 30 that energizes the rotation arms 26, 26 in the direction of the arrow D in FIG. 5A. Therefore, the slide cam 31 is rotated toward and held on the side of the front part 12a of the lens tube 12 against the energizing force of the torsion coil spring 30, and the lens barrier 13 keeps opening the image pickup lens 10.

Since the cam body 35 is held on the side of the front part 12a of the lens tube 12, the slide cam 31 is abutted against the power switch 40. This turns on the main power of the image pickup unit including the lens unit 4, making the apparatus ready for image pickup.

As described above, in the image pickup apparatus 1, as the movement mechanism 33 slides the slide cam 31, the lens barrier 13 for preventing taint and damage to the image pickup lens 10 can be rotated upward in the direction substantially orthogonal to the optical axis of the image pickup lens 10 so as to open the image pickup lens 10, and the main power of the image pickup unit can be turned on, interlocked with the rotation of the lens barrier 13. Therefore, in this image pickup apparatus 1, a large rotation space for the lens barrier 13 need not be provided on the front part 12a of the lens tube 12 and the apparatus body 2 can be miniaturized. Moreover, in the image pickup apparatus 1, the main power of the image pickup unit can be turned on, interlocked with the rotation of the lens barrier 13. The operation necessary for preparation for image pickup can be simplified and the number of components can be reduced.

When image pickup ends and the operator operates the lens opening/closing button of the operating unit formed on the body part 3 or the like, the driving motor 44 of the movement mechanism 33 is driven and the engagement piece is moved along the slide wall 45a of the housing 45 via the gear part 43 in the direction opposite to the arrow E in FIGS. 6B and 8 from the front part 12a toward the rear part 12b of the lens tube 12.

As the engagement piece 41 is moved in the direction opposite to the arrow E, the engagement part 37 of the slide cam 31 engaged with the engagement protrusion 41a of the engagement piece 41 is pressed by the engagement protrusion 41a, and the slide cam 31 is slid in the direction opposite to the arrow E in FIG. 6B against the energizing force of the torsion coil spring 34.

In the lens barrier 13, this releases the abutment part 28 of the rotation arms 26 from the energizing force applied from the pressing part 36 of the cam body 35, and the energizing force of the torsion coil spring 30 rotates the rotation arms 26 in the direction of the arrow D in FIGS. 6A and 8. As the rotation arms 26 rotate in the direction of the arrow D, the barrier part 25 of the lens barrier 13 covers the aperture 15 of the lens unit 4 and protects the image pickup lens 10 from taint and damage.

When the slide cam 31 is slid toward the rear part 12b of the lens tube 12 and the cam body 35 is held on the side of the rear part 12b of the lens tube 12, the abutment of the cam body 35 against the power switch 40 is canceled and the main power of the image pickup unit of the image pickup apparatus 1 is turned off.

As described above, in this image pickup apparatus 1, as the movement mechanism 33 slides the slide cam 31, the lens barrier 13 can be rotated downward in the direction substantially orthogonal to the optical axis of the image pickup lens 10 so as to protect the image pickup lens 10 from taint and damage, and the main power of the image pickup unit can be turned off, interlocked with the rotation of the lens barrier 13. Therefore, in the image pickup apparatus 1, a large rotation space for the lens barrier 13 need not be provided on the front part 12a of the lens tube 12 and the apparatus can be miniaturized. Moreover, in the image pickup apparatus 1, the main power of the image pickup unit can be turned off, interlocked with the rotation of the lens barrier 13. The operation after the end of image pickup can be simplified and the number of components can be reduced.

In the image pickup apparatus 1, the lens barrier 13 is opened/closed by using the two torsion coil springs 30, 34 having different energizing forces for rotating the lens barrier 13. Therefore, even if the user's finger or other foreign matter is caught in the lens barrier 13 when closing the lens barrier 13, an excessive load is not put on the movement mechanism 33 and the lens barrier will not lose its durability.

In the above-described image pickup apparatus 1, the rotation arms 26, 26 of the lens barrier 13 are rotationally energized in the direction of the arrow D in FIGS. 7 and 8 by the torsion coil spring 30. However, the rotation arms 26, 26 may be rotationally energized in the opposite direction. In this case, the rotation arms 26, 26 are rotationally energized in the direction opposite to the arrow D in FIGS. 7 and 8 by the torsion coil spring 30, and the pressing part 36 of the slide cam 31 is abutted against the abutment part 28 of the lens barrier 13 from the front part 12a of the lens tube 12.

Thus, when the slide cam 31 is slid toward the rear part 12b of the lens tube 12, the lens barrier 13 is pressed by the pressing part 36 of the slide cam 31 against the energizing force of the torsion coil spring 30 and rotated in the direction of the arrow D in FIG. 8 for covering the image pickup lens 10. On the other hand, when the slide cam 31 is slid toward the front part 12a of the lens tube 12, the energizing force by the pressing part 36 of the slide cam 31 is canceled and the lens barrier 13 is rotated in the direction opposite to the arrow D in FIG. 7 for opening the image pickup lens 10.

Another lens barrier mechanism to which this invention is applied and an image pickup apparatus using this lens barrier mechanism will now be described in detail with reference to the drawings.

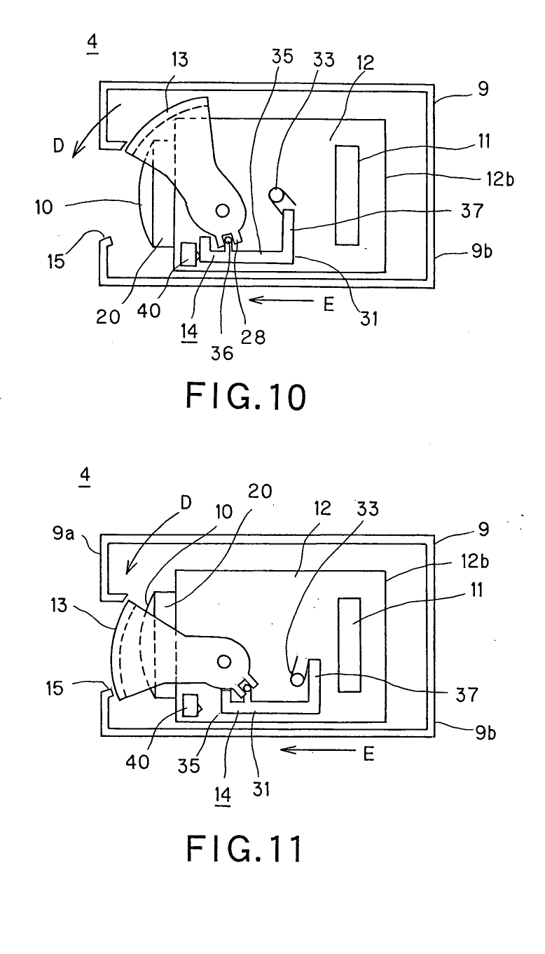

A lens unit 4 of this image pickup apparatus 1 has a casing 9 made of a substantially rectangular solid, and in the casing 9, a lens tube 12 in which an image pickup lens 10 and an image pickup device 11 such as CCD are provided, a lens barrier 13 rotated from the top part of the image pickup lens 10 shown in FIG. 10 to the front part of the image pickup lens shown in FIG. 11 so as to protect the image pickup lens 10, and a movement mechanism 14 for moving the lens barrier 13 are provided, as shown in FIGS. 10 and 11.

In a front part 9a of the casing 9, an aperture 15 for exposing the image pickup lens 10 outward is formed, as shown in FIGS. 10 and 11. An audio microphone 17 is provided on a top part 9c of the casing 9.

On one lateral part 9e of the casing 9, an operation aperture 18 is formed through which a slide cam of the movement mechanism 14 to be described later is exposed outward and is made slidable.

On a front part 12a of the lens tube 12, which holds the image pickup lens 10 and the image pickup device 11, a lens holder 20 for holding the image pickup lens 10 is provided on a front part 12a, and an image pickup device housing part 21 for housing the image pickup device 11 such as CCD is formed on a rear part 12b of the lens tube 12, as shown in FIGS. 7 and 8. On a lateral part 12c of the lens tube 12, the lens barrier 13 rotating vertically on the front side of the image pickup lens 10 so as to protect the image pickup lens 10 is attached, and the movement mechanism 14 for moving the lens carrier 13 while regulating the rotation of the lens barrier 13 is formed on a bottom part 12d of the lens tube 12.

One or plural image pickup lenses 10 are held by the lens holder 20. The image pickup lens 10 is held to be movable in the direction of the optical axis by a focusing mechanism, not described in detail. The image pickup lens 10 is focus-controlled by the focusing mechanism that has received a control signal from a control unit provided in the lens unit 4.

The image pickup device 11 such as CCD housed in the image pickup device housing part 21 photoelectrically converts an image entered to the image pickup lens 10, thus generates an image signal and outputs this image signal to a signal processing circuit formed in the body part 3.

The lens barrier 13 rotatably attached on the lateral part 12c of the lens tube 12 has a substantially rectangular barrier part 25 for protecting the image pickup lens 10, a pair of rotation arms 26, 26 extended from both lateral parts of the barrier part 25, and rotation supporting parts 27, 27 for supporting the rotation arms 26, 26 in a rotatable manner.

The barrier part 25 is formed in a substantially rectangular plate-like shape and is slightly curved in an arcuate shape along the rotating direction. The barrier part 25 is large enough to cover the entire surface of the image pickup lens 10. As the barrier part 25 is connected with the rotation arms 26, 26, the barrier part 25 is rotated arcuately between the front part and the top part of the image pickup lens 10 by the rotation of the rotation arms 26, 26.

The distal ends 26a of the pair of rotation arms 26, 26 are continued to the barrier part 25 and their proximal ends 26b are attached to the lateral parts of the lens tube 12 in a rotatable manner by the rotation supporting parts 27, 27. As the rotation arms 26, 26 are supported by the rotation supporting parts 27, 27, the rotation arms 26, 26 can rotate in the direction of an arrow D in FIGS. 7 and 8 for closing the aperture 15 of the lens unit 4 and the direction opposite to the arrow D in FIGS. 7 and 8 for opening the aperture 15 and exposing the image pickup lens 10 outward, both direction being substantially orthogonal to the direction of the optical axis of the image pickup lens 10.

A torsion coil spring 30 is wound on one of the rotation supporting parts 27 for supporting the rotation arms 26. As this torsion coil spring 30 has its one end retained by the rotation arm 26 and has its other end retained by the lens tube 12, it constantly energizes the rotation arms 26, 26 in the direction of the arrow D in FIGS. 7 and 8 for the barrier part 25 to cover the image pickup lens 10. On the proximal end 26b of the rotation arms 26, 26, an engagement recess 28 to be engaged with an engagement protrusion formed on the slide cam of the movement mechanism 14, which will be described later, is formed. The engagement recess 28 is substantially U-shaped and holds the engagement protrusion of the slide cam therein in a slidable manner. As the engagement recess 28 is moved in accordance with the sliding of the slide cam via the engagement protrusion, the rotation arms 26, 26 rotate in the direction of the arrow D or the direction opposite to the arrow D in FIGS. 7 and 8.

Upper and lower stopper walls 22, 23 for regulating the rotation range of the rotation arms 26, 26 are formed on the lateral part 12c of the lens tube 12. The rotation arms 26, 26 rotate between these upper and lower stopper walls 22, 23.

As the lens barrier 13 is rotatably supported by the rotation supporting parts 27 provided on both lateral parts of the lens tube 12 and having a rotational axis orthogonal to the direction of the optical axis of the image pickup lens 10, the lens barrier 13 is rotatable in the direction of the arrow D and the direction opposite to the arrow D in FIGS. 7 and 8, which are substantially orthogonal to the optical axis of the image pickup lens 10. As the rotation arms 26 are rotated by the slide cam via the engagement recess 28, the lens barrier 13 rotates in the direction of the arrow D in FIG. 11 for covering the image pickup lens 10 or in the direction opposite to the arrow D in FIG. 10. The lens barrier 13 thus rotates between the front position on the image pickup lens 10 for preventing taint and damage to the image pickup lens and the top position on the image pickup lens 10 for the barrier part 25 to open the image pickup lens 10.

The movement mechanism 14, which moves the lens barrier 13 by regulating the rotation of the rotation arms 26, 26, is formed on the bottom part 12d of the lens tube 12. The movement mechanism 14 has a slide cam 31 for pressing the rotation arms 26, 26, a pair of guide shafts 32, 32 arranged parallel to the optical axis of the image pickup lens 10 and adapted for guiding the movement of the slide cam 31, and a toggle spring 33 for energizing the slide cam 31 between one end and the other end of the guide shafts 32, 32.

The slide cam 31 has a substantially rectangular plate-like cam body 35, an engagement protrusion 36 continued to the cam body 35 and engaged with the engagement recess 28 of the rotation arm 26 in a slidable manner, and a retaining wall 37 engaged with one end of the toggle spring 33 and energized by the toggle spring 33, as shown in FIGS. 7 and 8. From the front side to the rear side of the cam body 35, a pair of insertion holes 38, 38 are provided in which the pair of guide shafts 32, 32 are inserted. The cam body 35 is guided by the guide shafts 32, 32 arranged parallel to the optical axis of the image pickup lens 10 and is thus made movable in the direction of an arrow E and the direction opposite to the arrow E in FIGS. 7 and 8, which are parallel to the optical axis of the image pickup lens 10.

The slide cam 31 has the cam body 35 exposed outward from the operation aperture 18 provided in the one lateral part 9e of the casing 9 and thus can be slid by the operator of the image pickup apparatus 1.

From one lateral part of this cam body 35, the engagement protrusion 36 held in the engagement recess 28 of the rotation arm 26 is extended. The engagement protrusion 36 is held in the substantially U-shaped engagement recess 28 and moves the engagement recess 28 of the rotation arm 26 in the direction of the arrow E and the direction opposite to the arrow E in FIGS. 7 and 8 in accordance with the movement of the cam body 35.

The retaining wall 37 retaining the toggle spring 33 is formed to rise on the rear side of the cam body 35. The cam body 35 receives the energizing force 33 from the retaining wall 37 and is thus moved in the direction of the arrow E and the direction opposite to the arrow E in FIGS. 10 and 11.

The toggle spring 33 has its one end retained on the side of the lens tube 12 and has its other end retained by the retaining wall 37. When the slide cam 31 is slid toward the rear part 12b of the lens tube 12 as shown in FIG. 11, the toggle spring 33 energizes the cam body 35 toward the rear part 12b of the lens tube 12. When the slide cam 31 is slid toward the front part 12a of the lens tube 12 as shown in FIG. 10, the toggle spring 33 energizes the cam body 35 toward the front part 12a of the lens tube 12.

In the movement mechanism 14 as described above, the slide cam 31 exposed from the operation aperture 18 provided in the casing 9 of the lens unit 4 is slid between the front part 12a and the rear part 12b of the lens tube 12 by the operator of the image pickup apparatus 1.

When the slide cam is slid from the rear part 12b toward the front part 12a, the toggle spring 33 is reversed from the position where it energizes the cam body 35 toward the rear part 12b shown in FIG. 11 to the position where its energizes the cam body 35 toward the front part 12a shown in FIG. 10. Therefore, the slide cam 31 is held on the side of the front part 12a of the lens tube 12. As the slide cam 31 slides, the engagement protrusion 36 of the cam body 35 moves the engagement recess 28 of the rotation arm 26 in the direction of the arrow E in FIGS. 7 and 8 and the rotation arms 26, 26 rotate in the direction opposite to the arrow D in FIGS. 7 and 8. The barrier part 25 thus opens the image pickup lens 10, enabling image pickup.

In this case, the slide cam 31 is held on the side of the front part 12a of the lens tube 12 by the energizing force of the toggle spring 33. Since the rotation arms 26, 26 are held in the rotating state in the direction opposite to the arrow D in FIGS. 7 and 8, the barrier part 25 of the lens barrier 13 keeps opening the image pickup lens 10.

On the other hand, when the slide cam 31 is slid from the front part 12a toward the rear part 12b, the toggle spring 33 is reversed from the position where it energizes the cam body 35 toward the front part 12a shown in FIG. 10 to the position where it energizes the cam body 35 toward the rear part 12b shown in FIG. 11. Therefore, the slide cam 31 is held on the side of the rear part 12b of the lens tube 12. As the slide cam 31 slides, the engagement protrusion 36 of the cam body 35 is moved in the direction opposite to the arrow E in FIGS. 7 and 8 and also the engagement recess 28 of the rotation arm 26 is moved in the direction opposite to the arrow E in FIGS. 7 and 8 by the movement of the engagement protrusion 36. The rotation arms 26, 26 of the lens barrier 13 thus rotate in the direction of the arrow D in FIGS. 7 and 8 and the barrier part 25 covers the image pickup lens 10.

On the front part 12a of the lens tube 12, a power switch 40 for the lens unit 4 capable of performing image pickup by itself is provided facing the cam body 35 of the slide cam 31. As the power switch 40 is abutted against the cam body 35 of the slide cam 31 slid toward the front part 12a of the lens tube 12, the main power of the lens unit 4 turned on. As the slide cam 31 is slid toward the rear part 12b of the lens tube 12 and the power switch 40 is separated away from the cam body 35, the main power of the lens unit 4 is turned off.

In the image pickup apparatus 1 having the above-described structure, before it is used, the slide cam 31 is held on the side of the rear part 12b of the lens tube 12 and the engagement recess 28 of the rotation arms 26 is moved toward the rear part 12b by the engagement protrusion 36, as shown in FIG. 8. Therefore, the rotation arms 26, 26 are rotated in the direction of the arrow D and the lens barrier 13 covers the image pickup lens 10.

At the time of image pickup, the slide cam 31 exposed from the operation aperture 18 of the lens unit 4 is slid by the operator toward the front part 12a of the lens tube 12. The engagement recess 28 in the lens barrier 13 is moved in the direction of the arrow E in FIG. 11 by the engagement protrusion 36 of the cam body 35 and the rotation arms 26, 26 rotate in the direction opposite to the arrow D in FIG. 7. As the rotation arms 26, 26 rotate in the direction opposite to the arrow D, the barrier part 25 of the lens barrier 13 is rotated upward and opens the image pickup lens 10, thus enabling image pickup.

As the slide cam 31 is slid toward the front part 12a of the lens tube 12, the energizing direction of the toggle spring 33 retained by the retaining wall 37 of the cam body 35 is reversed and the toggle spring 33 energizes the cam body in the direction of the arrow E in FIG. 10. Therefore, the cam body 35 is held on the side of the front part 12a. Also the engagement recess 28 of the rotation arms 26, 26 is held on the side of the front part 12a of the lens tube 12, and the lens barrier 13 keeps opening the image pickup lens 10.

Moreover, as the cam body 35 is held on the side of the front part 12a of the lens tube 12, the slide cam 31 is abutted against the main power switch 40. This turns on the main power of the lens unit 4 for the apparatus body 2 and makes the apparatus ready for image pickup.

As described above, in the image pickup apparatus 1, as the slide cam 31 is slid, the lens barrier 13 for preventing taint and damage to the image pickup lens 10 can be rotated upward in the direction substantially orthogonal to the optical axis so as to open the image pickup lens 10, and the main power of the lens unit 4 capable of performing image pickup by itself can be turned on, interlocked with the rotation of the lens barrier 13. Therefore, in this image pickup apparatus 1, a large rotation space for the lens barrier 13 need not be provided on the front part 12a of the lens tube 12 and the apparatus body 2 can be miniaturized. Moreover, in the image pickup apparatus 1, the main power of the lens unit 4 can be turned on, interlocked with the rotation of the lens barrier 13. The operation necessary for preparation for image pickup can be simplified and the number of components can be reduced.

When image pickup ends, the operator slides the slide cam 31 toward the rear part 12b of the lens tube 12. In the lens barrier 13, the engagement recess 28 of the rotation arm 26 is rotated in the direction of the arrow D in FIG. 11 by the engagement protrusion 36 of the cam body 35. As the rotation arms 26, 26 rotate in the direction of the arrow D, the barrier part 25 of the lens barrier 13 rotates downward and covers the image pickup lens 10, thus protecting the image pickup lens 10 from taint and damage.

As the slide cam 31 is slid toward the rear part 12b of the lens tube 12, the energizing direction of the toggle spring 33 retained by the retaining wall 37 of the cam body 35 is reversed and the toggle spring 33 energizes the cam body 35 in the direction opposite to the arrow E in FIG. 11. Therefore, the cam body 35 is held on the side of the rear part 12b and the lens barrier 13 keeps covering the image pickup lens 10.

Moreover, as the slide cam 31 is slid toward the rear part 12b of the lens tube 12 and the cam body 35 is held on the side of the rear part 12b, the abutment of the cam body 35 against the main power switch 40 is canceled in the image pickup apparatus 1, and the main power of the lens unit 4 is turned off.

As described above, in this image pickup apparatus 1, as the slide cam 31 is slid, the lens barrier 13 can be rotated downward in the direction substantially orthogonal to the optical axis of the image pickup lens 10 so as to protect the image pickup lens 10 from taint and damage, and the main power of the lens unit 4 capable of performing image pickup by itself can be turned off, interlocked with the rotation of the lens barrier 13. Therefore, in the image pickup apparatus 1, a large rotation space for the lens barrier 13 need not be provided on the front part 12a of the lens tube 12 and the apparatus can be miniaturized. Moreover, in the image pickup apparatus 1, the main power of the lens unit 4 can be turned off, interlocked with the rotation of the lens barrier 13. The operation after the end of image pickup can be simplified and the number of components can be reduced.

In the camera lens barrier to which this invention is applied and the image pickup apparatus using this camera lens barrier, the lens barrier may be divided into upper and lower barrier parts. Hereinafter, an image pickup apparatus 50 having a lens barrier 51 including upper and lower barrier parts will be described. The same members as those of the image pickup apparatus 1 are denoted by the same numerals and will not be described further in detail.

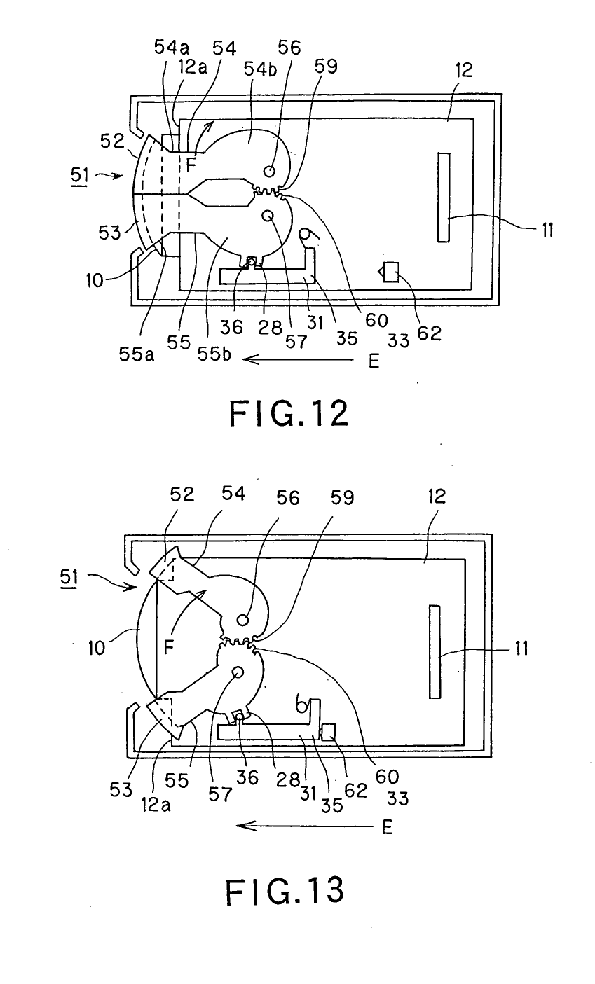

This lens barrier 51 has upper and lower barrier parts 52, 53, a pair of upper rotation arms 54 and a pair of lower rotation arms 55 extended from both lateral parts of the upper and lower barrier parts 52, 53, and upper and lower rotation supporting parts 56, 57 for rotatably supporting the upper and lower rotation arms 54, 55, as shown in FIGS. 12 and 13.

The upper and lower barrier parts 52, 53 are formed in a substantially rectangular shape and slightly curved in an arcuate shape along the direction of rotation substantially orthogonal to the optical axis of the image pickup lens 10. When abutted against each other, the upper and lower barrier parts 52, 53 are large enough to cover the entire surface of the image pickup lens 10. As the upper barrier part 52 is connected with the upper rotation arms 54 and the lower barrier part 53 is connected with the lower rotation arms 55, the upper and lower barriers 52, 53 are arcuately rotated from the front side to the top part and the bottom parts of the image pickup lens 10, respectively, by the rotation of the upper and lower rotation arms 54, 55.

The distal ends 54a, 55a of the pairs of upper and lower rotation arms 54, 55 are continued to the upper and lower barrier parts 52, 53 and their proximal ends 54b, 55b are attached to the lateral parts of the lens tube 12 in a rotatable manner by the upper and lower rotation supporting parts 56, 57. As the pairs of upper and lower rotation arms 54, 55 are supported by the upper and lower rotation supporting parts 56, 57, the rotation arms 54, 55 rotate in the direction of an arrow F in FIGS. 12 and 13 for covering the image pickup lens 10 and the direction opposite to the arrow F in FIGS. 12 and 13 for opening the image pickup lens 10, both direction being substantially orthogonal to the direction of the optical axis of the image pickup lens 10.

Gear parts 59, 60 to be engaged with each other are formed at the proximal ends 54b, 55b of the upper and lower rotation arms 54, 55. The upper and lower rotation arms 54, 55 rotated in the opposite directions, interlocked with each other via the gear parts 59, 60. Specifically, when the lower rotation arms 55 rotate in the direction of the arrow F in FIG. 12, the upper rotation arms 54 rotate in the direction opposite to the arrow F in FIG. 12, interlocked with the lower rotation arms 55. The upper and lower barrier parts 52, 53 connected with the distal ends 54a, 55a of the upper and lower rotation arms 54, 55 thus rotate toward the front side of the image pickup lens 10 to cover the image pickup lens 10. On the other hand, when the lower rotation arms 55 rotate in the direction opposite to the arrow F in FIG. 13, the upper rotation arms 54 rotate in the direction of the arrow F in FIG. 13, interlocked with the lower rotation arms 55. The upper and lower barrier parts 52, 54 thus rotate toward the top and bottom sides of the image pickup lens 10 to open the image pickup lens 10.

As the engagement recess 28 for holding the engagement protrusion 36 of the slide cam 31 is formed on the lower rotation arms 55 similarly to the rotation arms 26 of the image pickup apparatus 1 and the slide cam is slid in the direction of an arrow E or the direction opposite to the arrow E in FIGS. 12 and 13, the engagement recess 28 is moved by the engagement protrusion 36 and rotate in the direction of the arrow F or the direction opposite to the arrow F in FIGS. 12 and 13. Interlocked with the operation of the lower rotation arms 55, the upper rotation arms 54 rotate in the direction opposite to the arrow F or the direction of the arrow F in FIGS. 12 and 13 via the gear parts 59, 60.

The movement mechanism 14 for moving this lens barrier 51 has the slide cam 31, the pair of guide shafts 32, 32 for guiding the movement of the slide cam 31, and the toggle spring 33 for energizing the slide cam 31 between one end side and the other end side of the guide shafts 32, 32, as described above.

On the slide cam 31, the engagement protrusion 36 to be held in a slidable manner in the engagement recess 28 of the lower rotation arms 55 is formed. As this engagement recess 36 is held in the engagement recess 28 of the lower rotation arms 55 and the slide cam 31 is slid, the engagement recess 36 presses the lower rotation arms 55 in the direction of the arrow E or the direction opposite to the arrow E in FIGS. 12 and 13.

On the rear part 12b of the lens tube 12, a main power switch 62 of the lens unit 4 is formed facing the cam body 35 of the slide cam 31. When the main power switch 62 is abutted against the cam body 35 of the slide cam 31 slid toward the rear part 12b of the lens tube 12, it turns on the main power of the lens unit 4. When the slide cam 31 is slid toward the front part 12a of the lens tube 12 and the main power switch 62 is separated away from the cam body 35, it turns off the main power of the lens unit 4.

In the image pickup apparatus 50 as described above, before it is used, the slide cam 31 is held on the side of the front part 12a of the lens tube 12, as shown in FIG. 12. The lower rotation arms 55 rotate in the direction of the arrow F for covering the image pickup lens 10, via the engagement recess 28 holding the engagement protrusion 36, and the upper rotation arms 54 rotate in the direction opposite to the arrow F for covering the image pickup lens 10, interlocked with the lower rotation arms 55. Therefore, the upper and lower barrier parts 52, 53 rotate to the front side of the image pickup lens 10 and thus protect the image pickup lens 10.

In the image pickup apparatus 50, at the time of image pickup, the slide cam 31 is slid toward the rear part 12b of the lens tube 12 by the operator. The engagement recess 28 is thus moved in the direction opposite to the arrow E in FIG. 13 by the engagement protrusion 36 of the cam body 35, and the lower rotation arms 55 rotate in the direction opposite to the arrow F in FIG. 13. As the lower rotation arms 55 rotate in the direction opposite to the arrow F, the lower barrier part 53 rotates downward to open the image pickup lens 10. At the same time, the upper rotation arms 54 rotate in the direction of the arrow F via the gear parts 59, 60, interlocked with the rotation of the lower rotation arms 55. Therefore, in the image pickup apparatus 50, the upper and lower barrier parts 52, 53 rotate from the front side to the top and bottom sides of the image pickup lens 10 and open the image pickup lens 10, thus enabling image pickup.

As the slide cam 31 is slid toward the rear part 12b of the lens tube 12, the energizing direction of the toggle spring 33 retained by the retaining wall 37 of the cam body 35 is reversed and the toggle spring 33 energizes the cam body 35 in the direction opposite to the arrow E in FIG. 13. Therefore, the cam body 35 is held on the side of the rear part 12b and the lens barrier 51 keeps opening the image pickup lens 10.

Moreover, as the cam body 35 is held on the rear part 12b of the lens tube 12, the slide cam 31 is abutted against the main power switch 62. This turns on the main power of the lens unit 4 of the image pickup apparatus 50, making the apparatus ready for image pickup.

In the image pickup apparatus 50, when image pickup ends, the slide cam 31 is slid toward the front part 12a of the lens tube 12 by the operator. In the lens barrier 51, the engagement protrusion 36 of the cam body 35 slides toward the front part 12a and the lower rotation arms 55 rotate in the direction of the arrow F in FIG. 12 via the engagement recess 28. Interlocked with rotation of the lower rotation arms 55 in the direction of the arrow F, the upper rotation arms 54 rotate in the direction opposite to the arrow F via the gear parts 59, 60. Therefore, the upper and lower barrier parts 52, 53 rotate to the front side of the image pickup lens 10 and cover the image pickup lens 10, thus protecting the image pickup lens 10 from taint and damage.

As the slide cam 31 is slid toward the front part 12a of the lens tube 12, the energizing direction of the toggle spring 33 retained by the retaining wall 37 of the cam body 35 is reversed and the toggle spring 33 energizes the cam body 35 in the direction of the arrow E in FIG. 12. Therefore, the cam body 35 is held on the side of the front part 12a and the lens barrier 51 keeps covering the image pickup lens 10.

Moreover, as the slide cam 31 is slid toward the front part 12a of the lens tube 12 and the cam body 35 is held on the side of the front part 12a, the abutment of the cam body 35 against the main power switch 62 is canceled and the main power of the lens unit 4 is turned off.

As described above, in this image pickup apparatus 50, as the slide cam 31 is slid, the lens barrier 51 for preventing taint and damage to the image pickup lens 10 can be rotated upward and downward in the directions substantially orthogonal to the optical axis of the image pickup lens 10 so as to open the image pickup lens 10, and the main power of the lens unit 4 can be turned on and off, interlocked with the opening/closing operation. Therefore, in this image pickup apparatus 50, a large rotation space for the lens barrier 51 need not be provided on the front part 12a of the lens tube 12 and the apparatus can be miniaturized. Moreover, in the image pickup apparatus 50, the main power of the lens unit 4 can be turned on and off, interlocked with the rotation of the lens barrier 51. The operations at the time of image pickup and after image pickup can be simplified and the number of components can be reduced.

In the camera lens barrier to which this invention is applied and the image pickup apparatus using this camera lens barrier, the image pickup lens may be opened or covered by the operator directly rotating the lens barrier. Hereinafter, an image pickup apparatus 70 in which the operator directly rotates the lens barrier will be described. The same members as those of the image pickup apparatus 1 are denoted by the same numerals and will not be described further in detail.

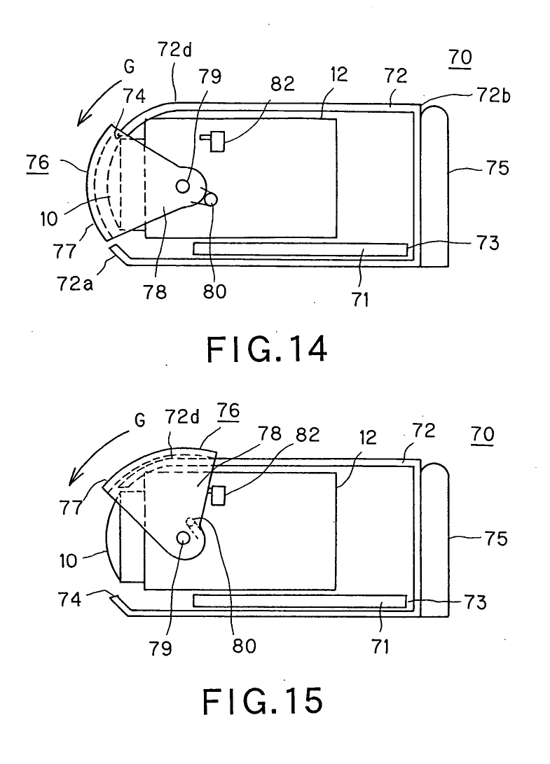

A lens unit 72 of this image pickup apparatus 70 has the lens tube 12 in which the image pickup lens 10 and the image pickup device 11 or the like are provided, and a recording medium housing part 73 in which a recording medium 71 for recording picked-up video data is housed, as shown in FIGS. 14 and 15. An aperture 74 for exposing the image pickup lens 10 outward is formed on a front part 72a of the lens unit 72, and an LCD (liquid crystal display) panel 75 for projecting the picked-up image is formed on a rear part 72b.

Moreover, a lens barrier 76 that rotates upward and downward on the front side of the aperture 74 exposing the image pickup lens 10 and thus protects the image pickup lens 10 is attached on the lens unit 72. Similar to the lens barrier 13 provided in the image pickup apparatus 1, the lens barrier 76 has a barrier part 77, a pair of rotation arms 78, 78, and rotation supporting parts 79, 79 for rotatably supporting the rotation arms 78, 78.

As the rotation arms 78, 78 are rotatably supported by the rotation supporting parts 79, 79 formed on lateral parts 72c of the lens unit 72, the barrier part 77 of the lens barrier 76 connected to the distal ends of the rotation arms 78, 78 rotates between the front part 72a to a top part 72d of the lens unit 72 in directions substantially orthogonal to the optical axis of the image pickup lens 10.

Near the rotation supporting part 79 of the lens barrier 76, a toggle spring 80 for energizing the rotation arms 78, 78 toward the front part 72a or the top part 72d of the lens unit 72 is retained. When the lens barrier 76 rotates toward the front part 72a of the lens unit 72, the toggle spring 80 energizes the rotation arms 78 in a direction of an arrow G in FIG. 14 for the barrier part 77 to close the aperture 74 of the lens unit 72. When the lens barrier 76 rotates toward the top part 72d of the lens unit 72, the energizing direction of the toggle spring 80 is reversed and the toggle spring 80 energizes the rotation arms 78 in the direction opposite to the arrow G in FIG. 15 for the barrier part 77 to open the aperture 74.

In the lens unit 72, a main power switch 82 of the lens unit 72 is provided at the rotation position of the rotation arms 78 in the case where the lens barrier 76 rotates toward to the top part 72d of the lens unit 72. When the main power switch 82 is abutted against the rotation arms 78, 78 of the lens barrier 76 rotated toward the top part 72d of the lens unit 72, it turns on the main power of the lens unit 72. When the rotation arms 78, 78 of the lens barrier 76 rotated toward the front part 72a of the lens unit 72 are separated away from the main power switch 82, it turns off the main power of the lens unit 72.

In the image pickup apparatus 70 as described above, before it is used, the lens barrier 76 is held on the side of the front part 72a of the lens unit 72 and thus closes the aperture 74 for exposing the image pickup lens 10, as shown in FIG. 14. In this case, the rotation arms 78 of the lens barrier 76 are energized by the toggle spring 80 in the direction of the arrow G in FIG. 14 for closing the aperture 74.

At the time of image pickup, the lens barrier 76 is rotated toward the top part 72d of the lens unit 72 by the operator. The aperture 74 is thus opened and exposes the image pickup lens 10 outward. As the lens barrier 76 is rotated toward the top part 72d, the energizing direction of the toggle spring 80 is reversed and the toggle spring 80 energizes the rotation arms 78 in the direction opposite to the arrow G in FIG. 15 for the barrier part 77 to open the aperture 74. Therefore, the barrier part 77 of the lens barrier 76 is held on the side of the top part 72d of the lens unit 72 by the energizing force of the toggle spring 80, and the aperture 74 is opened during image pickup.

In the image pickup apparatus 70, as the rotation arms 78 are rotated toward the top part 72d of the lens unit 72 and thus abutted against the main power switch 82, the power of the lens unit 72 is turned on, enabling image pickup.

When image pickup ends, the lens barrier 76 is rotated toward the front part 72a of the lens unit 72 by the operator. The aperture 74 is thus closed, and taint and damage to the image pickup lens 10 due to dust and particles can be prevented. As the lens barrier 76 is rotated toward the front part 72a, the energizing direction of the toggle spring 80 is reversed and the toggle spring 80 energizes the rotation arms 78 in the direction of the arrow G in FIG. 14 for the barrier part 77 to close the aperture 74. Therefore, the barrier part 77 of the lens barrier 76 is held on the side of the front part 72a of the lens unit 72 by the energizing force of the toggle spring 80, and the aperture 74 is closed when the apparatus is not used.

Moreover, as the rotation arms 78 are rotated toward the front part 72a of the lens unit 72 and separated away from the main power switch 82, the main power of the lens unit 72 of the image pickup apparatus 70 is turned off.

The image pickup apparatuses to which this invention is applied are described above. However, according to this invention, the lens unit may be removable from the body part and the lens unit may be capable of performing image pickup by itself. In this manner, in the image pickup apparatus to which this invention is applied, the lens unit can be directed to a position where the lens unit attached to the body part cannot pick up an image, and the degree of freedom in image pickup can be improved.

While the invention has been described in accordance with certain preferred embodiments thereof illustrated in the accompanying drawings and described in the above description in detail, it should be understood by those ordinarily skilled in the art that the invention is not limited to those embodiments, but various modifications, alternative constructions or equivalents can be implemented without departing from the scope and spirit of the present invention as set forth and defined by the appended claims.

1. A lens barrier mechanism comprising:
a lens tube;
a lens barrier rotated in a direction orthogonal to an optical axis of an image pickup lens exposed from a front part of the lens tube for opening/closing the front part of the lens tube;
a first energizing member for rotationally energizing the lens barrier;
a slider engaged with the lens barrier and sliding in a direction of the optical axis of the image pickup lens, thereby regulating rotation of the lens barrier;
a second energizing member for energizing the slider so as to rotate the lens barrier in a direction opposite to an energizing direction of the first energizing member; and
a sliding mechanism for moving the slider.

2. The lens barrier mechanism as claimed in claim 1, wherein the sliding mechanism moves the slider into in a direction opposite to an energizing direction of the second energizing member and rotates the lens barrier in the energizing direction of the first energizing member, thereby opening or closing the front part of the lens tube, and wherein the sliding mechanism moves the slider in the energizing direction of the second energizing member and rotates the lens barrier in the direction opposite to the energizing direction of the first energizing member by the energizing force of the second energizing member, thereby closing or opening the front part of the lens tube.

3. The lens barrier mechanism as claimed in claim 2, wherein the first energizing member rotationally energizes the lens barrier in a direction of closing the front part of the lens tube, and the second energizing member energizes the slider toward the front part of the lens tube.

4. The lens barrier mechanism as claimed in claim 2, wherein the sliding mechanism has an engagement member for engaging a rotary motor with the slider, and
the engagement member drives the rotary motor to move the slider in the direction of the optical axis of the image pickup lens.

5. The lens barrier mechanism as claimed in claim 1, wherein the second energizing member comprises a toggle spring.

6. The lens barrier mechanism as claimed in claim 5, further comprising a slide cam that is manually operated, wherein the toggle spring keeps energizing the slide cam in an operating direction.

7. A lens barrier mechanism comprising:
a lens tube;
a lens barrier rotated in a direction orthogonal to an optical axis of an image pickup lens exposed from a front part of the lens tube for opening closing the front part of the lens tube; and
an opening/closing mechanism for opening/closing the lens barrier and turning on or off a main power of an image pickup apparatus, interlocked with the opening/closing of the lens barrier.

8. The lens barrier mechanism as claimed in claim 7, wherein when the opening/closing mechanism is engaged with the lens barrier and rotated in an opening direction or closing direction of the lens barrier, the opening/closing mechanism is abutted against a main power switch of the image pickup apparatus and turns on the main power.

9. An image pickup apparatus comprising:
a lens tube;
an image pickup lens housed in the lens tube and exposed outward from a front part of the lens tube;
a lens barrier rotated in a direction orthogonal to an optical axis of the image pickup lens for opening/closing the front part of the lens tube;
a first energizing member for rotationally energizing the lens barrier;
a slider engaged with the lens barrier and sliding in a direction of the optical axis of the image pickup lens, thereby regulating rotation of the lens barrier;
a second energizing member for energizing the slider so as to rotate the lens barrier in a direction opposite to the energizing direction of the first energizing member; and
a sliding mechanism for moving the slider.
